(19) United States
(12) Patent Application Publication
(10) Pub. No.: US 2007/0068064 A1
(43) Pub. Date: Mar. 29, 2007

(54) FISH HOOK PROTECTOR

(76) Inventor: GEORGE PENFOLD, Hamilton (CA)

Correspondence Address: MARK A KOCH, 866 MAIN STREET EAST, HAMILTON, ON, L8M1L9, CA

(21) Appl. No.: 11/308,594

(22) Filed: Apr. 10, 2006

Related U.S. Application Data
(60) Provisional application No. 60/670,278, filed on Apr. 12, 2005.

(51) Int. Cl. A01K 97/06

(52) U.S. Cl. 43/57.1; 43/25.2

(57) ABSTRACT

The present invention is a fish hook protector for use with fishing hooks and fishing lures. The fish hook protector includes an elongated body operably capable of being penetrated by hook ends of fish hooks; wherein the elongated body being made of elastic resilient material operably capable of being resiliently stretched by pulling on the ends of the elongated body. Preferably the elongated body being a cylindrical rod having a length l and the body being made of an elastic resilient material including a UV protectant to prevent breakdown of the material when exposed to sunlight. In one embodiment the elongated body including at least two fins separated by an angle theta defined as the angle subtended between the fins, the fins attached to the body at a body end and terminating at a tip end wherein the fins projecting in a fin direction away from the body such that a trough is defined as the space between the fins.

### CROSS REFERENCE TO RELATED APPLICATIONS

The application claims priority from previously filed U.S. provisional patent application No: 60/670,278, titled “Fish Hook Protector” on Apr. 12, 2005 by George Penfold.

### FIELD OF THE INVENTION

The present invention pertains to fishing gear and more particularly pertains to a fish hook protector for use with lures having two or more spaced apart sets of treble hooks.

### BACKGROUND OF THE INVENTION

The average angler today keeps a tackle box complete with an array of hooked lures. Lures notoriously become entangled among themselves and with hooks of other lures. Even with numerous multi chambered tackle boxes, multiple hooked lures become intra entangled and the angler is always subject to snagging himself with attaching lures to his line. As a result a large number of hook point guards have been conceived of and are being used with a limited amount of success.

Known devices available as hook guards employ relatively complex geometries in regard to the configuration of the guard itself. The geometries limit production methods to that of mouldings or mouldings followed by other cutting and shaping operations with the associated production cost. The devices known on the market usually attempt to guide or protect the hook on an individual basis for example, in U.S. Pat. No. 6,691,448 issued Feb. 17, 2004 by George D. Jones titled Fish Hook Protector Guard, a shaped fish hook guard is designed to enclose various size fish hooks, treble hooks or gangs of fish hooks presently suspended from a lure. Each individual treble hook is enclosed in the fish hook guard and therefore, lures having two, three or more treble hooks require a number of these guards in order to be operative.

Another example is U.S. Pat. 4,121,368 issued Oct. 24, 1978 by James Norwood, titled Point Pads for Treble Point Fish Hooks, and describes a triangular shaped form foam pad, having a slot for facilitating placement of the pad over the shank of a hook which is attached to a line or a fishing lure. The hook points are in bedded into the underside of the pad which is normally made of soft foam like material. In this case, as in the previous, individual pads are required for each gang or set of treble hooks on the lure.

Therefore, there is a need for an inexpensive and easily attachable fish hook protector which can be used to simultaneously protect multiple gangs of fish hooks that are for example situated on the body of one lure.

### SUMMARY OF INVENTION

A fish hook protector for use with fishing lures having at least two sets of spaced apart treble hooks, the fish hook protector comprising an elongated body operably capable of being penetrated by at least one hook end of each treble hook such that the non penetrating ends of the treble hooks being held against the body of the lure.

The fish hook protector being made of elastic resilient material operably capable of being resiliently stretched by pulling on the ends of the elongated body when inserting hook ends into the body, such that the body tending to urge together the treble hook sets upon release of the resilient body thereby tightly holding the non penetrating hooks tightly against the body.

The fish hook protector claimed in claim 1 wherein the elongated body having a thickness t and a length l and an aspect ratio of at least three, wherein the length being at least three times the thickness.

The fish hook protector wherein the elongated body being a cylindrical rod having a length l.

The fish hook protector wherein the elongated body being made of an elastic resilient material including a UV protectant to prevent breakdown of the material when exposed to sunlight.

The fish hook protector wherein the elongated body including at least one fin attached to the body at a body end and terminating at a tip end wherein the fin projecting in a fin direction away from the body.

The fish hook protector wherein the elongated body including at least two fins separated by an angle theta defined as the angle subtended between the fins, the fins attached to the body at a body end and terminating at a tip end wherein the fins projecting in a fin direction away from the body such that a trough is defined as the space between the fins.

The fish hook protector wherein the fins being substantially flat planar surfaces.

The fish hook protector wherein the angle theta preferably between 25 and 155 degrees.

The fish hook protector wherein the fins lying parallel and in mirror image relationship to each other.

The fish hook protector wherein the fins made of the same elastic resilient material as the body.

The fish hook protector also includes a method of protecting fish hooks attached to lures having two or more sets of spaced apart hooks, the method including the steps of manually inserting a first hook into an elongated body of a fish hook protector wherein the elongated body capable of being penetrated by hook ends and being made of elastic resilient material operably capable of being resiliently stretched by pulling on the ends of the elongated body and inserting further spaced apart hooks into the elongated body by resiliently manually stretching the elongated body, wherein upon release of the stretched body it resiliently retracts and the fish hook penetrates into the body and embeds the fish hook end into the body.

### BRIEF DESCRIPTION OF THE DRAWINGS

The invention will now be described by way of example only with reference to the following drawings in which;

FIG. 1 is an end elevational view of the fish hook protector shown in FIG. 2.

FIG. 2 is a side plan view of the present invention a fish hook protector.

FIG. 3 is an end elevational view of the fish hook protector shown in FIG. 2.

FIG. 4 is a top perspective view of the fish hook protector shown in FIG. 2.

FIG. 5 is a side plan view of the fish hook protector shown deployed with a lure with treble hooks partially imbedded in the fish hook protector.

FIG. 6 is an end plan view of the fish hook protector shown in FIG. 5 together with a lure.

FIG. 7 is a front perspective view of the fish hook protector deployed with a lure showing the hook of the lure partially imbedded in the fish hook protector.

FIG. 8 is an end elevational view of an alternate embodiment of the present invention, a fish hooks protector shown in FIG. 9.

FIG. 9 is a side elevational view of a second embodiment of the present invention, a fish hooks protector.

FIG. 10 is an end plan view of the fish hook protector shown in FIG. 9.

FIG. 11 is a top perspective schematic view of the fish hook protector shown in FIG. 9.

FIG. 12 is a side perspective view of the fish hook protector shown in FIG. 11, deployed with a lure showing the hooks partially imbedded in the fish hook protector.

FIG. 13 is an end plan view of the fish hook protector deployed with a lure shown in FIG. 12.

FIG. 14 is a front perspective view of the fish hook protector shown in FIG. 11 deployed with a lure with the hooks partially imbedded in the fish hook protector.

### DETAILED DESCRIPTION OF THE PREFERRED EMBODIMENT

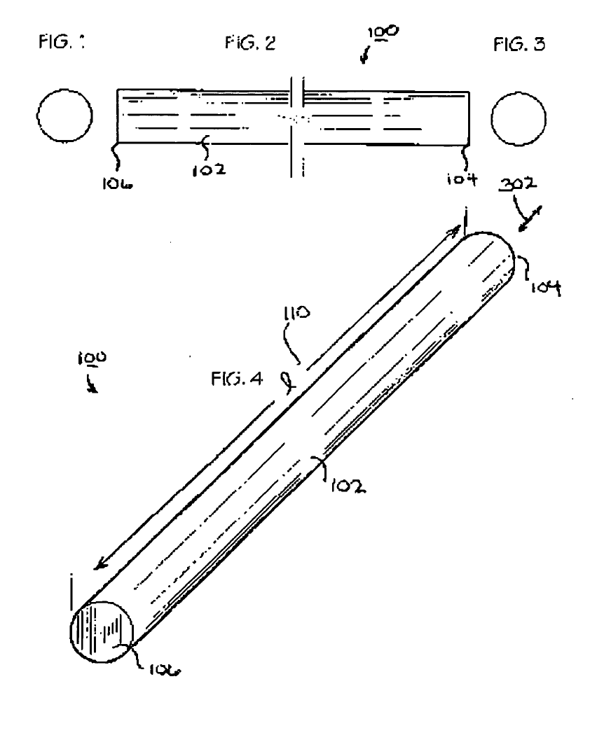

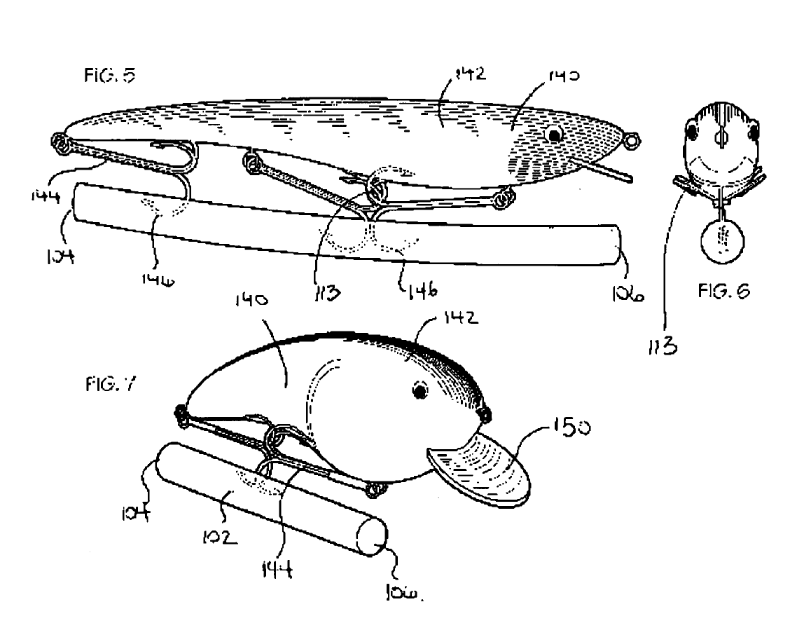

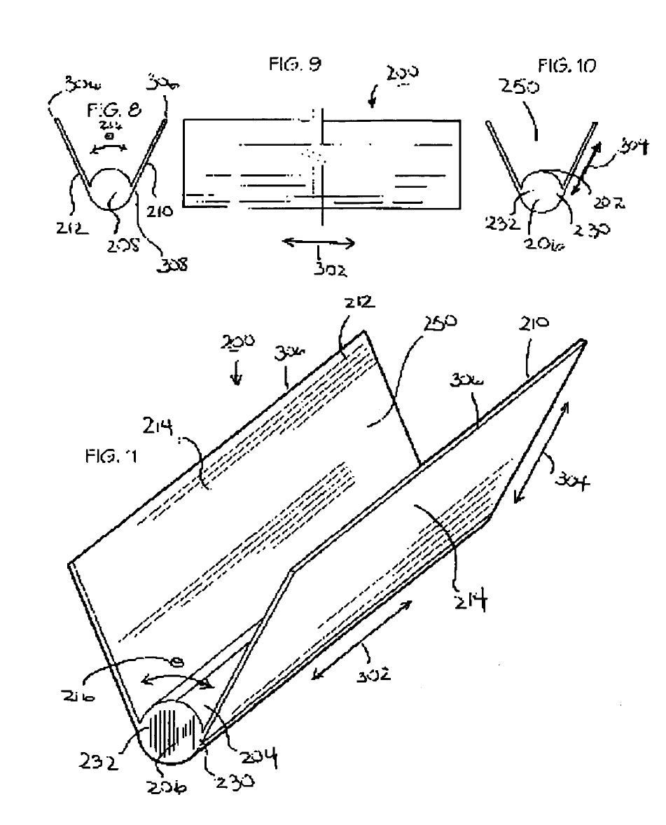

An embodiment of a fish hook protector is shown generally as 100 in FIGS. 1 through 7 and the second embodiment of the fish hook protector shown generally as 200 in FIGS. 8 through 14.

Fish hook protector 100 is a cylindrical shaped body 102, having a first end 106 and a second end 104. In the drawings, fish hook protector 100 is shown having a cylindrical or round cross section, however, in practise there is no reason why the body 102 of fish hook protector 100 could not have any other cross sectional shape, such as square, triangular, octagonal etc., provided it is an elongated rod like shaped body as suggested by the shape in FIG. 4.

Body 102, of fish hook protector 100 is made of a resilient elastic material which permits imbedding the hook into the material itself.

Body 102 has a variable length 110 and a thickness t 111. The aspect ratio being the ratio of the length compared to the diameter is at least 3 to 1 meaning the length is at least 3 times the thickness. Body 102 of hook protector 100 is a foam and/or rubberized type material which has some elasticity to allow it to be stretched to increase the over all length L 110 of body 102 when desired. It can be seen in FIGS. 5 and 7 for example, the length L 110 of body 102 is sufficient to span the length of the body 140 of lure 142. Body 102 has a longitudinal axis 302.

Referring to FIG. 5 for example, lure 142 has a total of three gangs of treble hooks 144 and fish hook protector 100 is positioned such that some hook ends 146 of treble hooks 144 are imbedded into fish hook protector 100 and other hook ends called non penetrating ends 113 are held closely against lure body 140 of lure 142.

In addition to the resiliency and the elasticity of the material used for body 102, it is also important that the material of the fish hook protector 100 also be UV resistant, worm proof, and soft enough to enable easy penetration of a hook end 146 into body 102.

The second embodiment of the fish hook protector 200 is depicted in FIGS. 8 through 14 and will be described here below.

Fish hook protector 200 includes the following major components, body 202 having a cylindrical portion 304, first end 206 and second end 208, a first fin 210, and second fin 212 oriented at an angle theta 216 relative of each other.

Body 202 is shown having a cylindrical shape namely cylindrical portion 204, however in practise, there is no reason why body 202 could not take on any particular elongated shape including square, triangular, hexagonal, octagonal etc. cross sections. Body 202 has a longitudinal axis 302 and fins 210 and 212 have fin direction 304.

Each fin 210 and 212 have a tip end and a body end 308.

First fin 210 emanates from the first side 230 of body 202 and second fin 212, emanates from the second side 232 of body 202. First and second fins 210 and 212 respectively are preferably integrally part of fish hook protector 200 and oriented relative to each other forming an angle theta 216 as shown in FIGS. 8 and 11. The space between first fin 210 and second fin 212 is a trough 250 which will accommodate a lure body 140 therein.

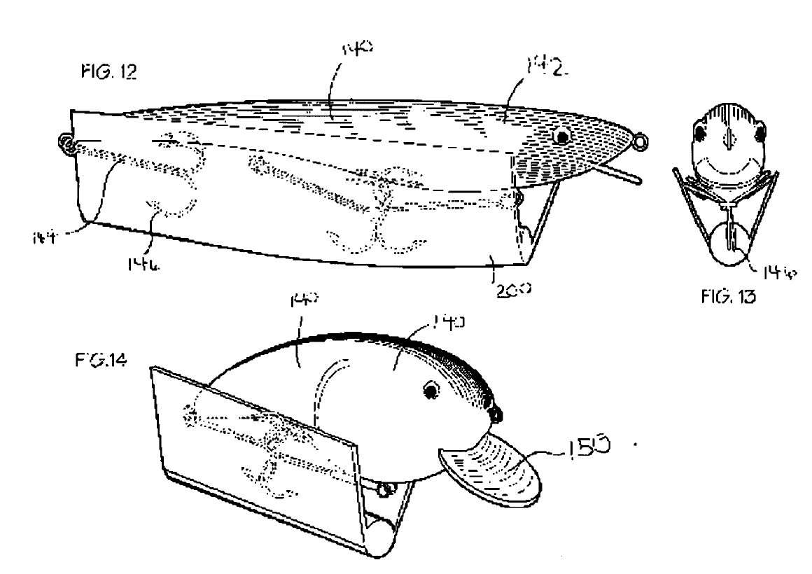

In FIGS. 12 through 14, fish hook protector 200 is shown together with a lure 142 having a number of treble hooks 144. As in the previous embodiment, some hook ends 146 of treble hooks 144 penetrate body 202 of fish hook protector 202 in such a manner as to lock treble hooks 144 into the cylindrical portion 204 of body 202 and at the same time hold the treble hooks 146 tightly against the lure body 140 as particularly shown in FIG. 13. In other words, only one of the three hook ends 146 of each treble hook 144 can be imbedded into the cylindrical portion 204 of body 202 as shown in FIG. 5 and FIG. 12. The other two hook ends 146 of each treble hook 144 are positioned such that they lie tightly adjacent to lure body 140.

Fish hook protector 200 is preferably made out of an elastic resilient material which is capable of being stretched by pulling on first end 206 and second end 208 of cylindrical portion 204 of body 202. One can grip first end 206 and second 208 and gently pull on body 202, such that it stretches and simultaneously imbeds the barbed end of hook end 146 into cylindrical portion 204 of body 202, such that by releasing first end 206 and/or second end 208 and allowing the elastic body 202 of fish hook protector 200 to contract, thereby imbedding hook end 146 into body 202. The same function is also applicable to fish hook protector 100. In this manner one, two or three of the hook ends 146 of each set of treble hooks 144 can be imbedded into body 202 and the remainder of the hook ends 146 not imbedded in body 202 will tightly push against lure body 140 because of the elastic contraction of body 202 of fish hook protector 200. The barbed ends of the hook ends 145 not imbedded into body 202 will be protected from contact with the fingers with the planer surface 214 of each of first fin 210 and second fin 212. The angle theta 216 between first fin 210 and second fin 212 is selected such that a trough 250 is defined as the space between first fin 210 and second fin 212 which will comfortably receive lure body 140 therein as shown and depicted in FIGS. 12,13 and 14.

Fish hook protector 200 can be made of a number of different materials that are commercially available, provided that the necessary properties can be achieved. The material should have some elasticity, it should have some UV resistance, it should be worm proof, and it should be durable and penetrable by the hook ends 146 of a treble hook 144.

The length of fish hook protector 200 is dependant upon the size of lure 142. In FIG. 12, a longer fish hook protector 200 is used, whereas in FIG. 14, which has only two treble hooks, a shorter fish hook protector is used. Normally, the length of fish hook protector will be dependent upon the length of lure 142 and the number of sets of treble hooks 144, attached to lure body 140. In addition, the length of lure body 140 will also have an affect upon the length of fish hook protector 200.

Fish hook protector 100 and 200 are essentially used the same way. The method of protecting fish hooks attached to lures which have two or more sets of spaced apart hooks, includes the following steps.

First of all manually inserting a first hook into elongated body 102 or 202. The elongated body 102 and 202 is capable of being penetrated by hook ends 146 since the body 102 and 202 is made of elastic resilient material capable of being resiliently stretched by pulling on the ends of the elongated body. The non penetrating ends 113 are positioned to lie against lure body 140.

Next further spaced apart hooks are inserted into the elongated body 102 or 202 by resiliently manually stretching the elongated body, wherein upon release of the stretched body 102 or 202 it resiliently retracts and the fish hook end 146 penetrates into body 102 or 202 and embeds the fish hook end into body 102 or 202. Simultaneously non penetrating ends are held closely against lure body 140.

As depicted in FIG. 5 or 12 for example lure 142 having three sets of treble hooks can be inserted onto fish hook protector 100 or 200. In this example lure 142 has three sets of treble hooks 144. As shown in the head on view in FIGS. 6 and 13 only one hook on the cluster of three hooks need be inserted into body 102 or 202. The remaining two hooks in each cluster are neatly tucked alongside body 102 or 202.

As shown in FIG. 12 for example lure body 114 is received and cradled in trough 250 which is the space between the fins 210 and 212. In this manner the hooks not embedded in body 202 are shielded by fins 210 and 212.

It should be apparent to persons skilled in the arts that various modifications and adaptation of this structure described above are possible without departure from the spirit of the invention the scope of which defined in the appended claim.

What is claimed is:

1. A fish hook protector for use with fishing lures having at least two sets of spaced apart treble hooks, the fish hook protector comprising an elongated body operably capable of being penetrated by at least one hook end of each treble hook such that the non penetrating ends of the treble hooks being held against the body of the lure.

2. The fish hook protector claimed in claim 1 wherein the elongated body being made of elastic resilient material operably capable of being resiliently stretched by pulling on the ends of the elongated body when inserting hook ends into the elongated body, such that the elongated body tending to urge together the treble hook sets upon release of the resilient body thereby holding the non penetrating hooks against the body of the lure.

3. The fish hook protector claimed in claim 1 wherein the elongated body having a thickness t and a length l and an aspect ratio of at least three, wherein the length being at least three times the thickness.

4. The fish hook protector claimed in claim 1 wherein the elongated body being a cylindrical rod having a length l.

5. The fish hook protector claimed in claim 1 wherein the elongated body being made of an elastic resilient material including a UV protectant to prevent breakdown of the material when exposed to sunlight.

6. The fish hook protector claimed in claim 1 wherein the elongated body including at least one fin attached to the body at a body end and terminating at a tip end wherein the fin projecting in a fin direction away from the body.

7. The fish hook protector claimed in claim 1 wherein the elongated body including at least two fins separated by an angle theta defined as the angle subtended between the fins, the fins attached to the body at a body end and terminating at a tip end wherein the fins projecting in a fin direction away from the body such that a trough is defined as the space between the fins.

8. The fish hook protector claimed in claim 6 and 7 wherein the fins being substantially flat planar surfaces.

9. The fish hook protector claimed in claim 7 wherein the angle theta preferably between 25 and 155 degrees.

10. The fish hook protector claimed in claim 7 wherein the fins lying parallel and in mirror image relationship to each other.

11. The fish hook protector claimed in claim 7 wherein the fins made of the same elastic resilient material as the body.

12. A method of protecting fish hooks attached to lures having two or more sets of spaced apart hooks, the method including the steps of, a) manually inserting a first hook into an elongated body of a fish hook protector and b) inserting further spaced apart hooks into the elongated body by resiliently manually stretching the elongated body, wherein upon release of the stretched body it resiliently retracts and the fish hook penetrates into the body and embeds the fish hook end into the body.

13. A system for protecting fish hooks attached to lures having two or more sets of spaced apart hooks, the system including manually inserting a first hook into an elongated body of a fish hook protector wherein the elongated body capable of being penetrated by hook ends and being made of elastic resilient material operably capable of being resiliently stretched by pulling on the ends of the elongated body and inserting further spaced apart hooks into the elongated body by resiliently manually stretching the elongated body, wherein upon release of the stretched body it resiliently retracts and the fish hook penetrates into the body and embeds the fish hook end into the body.

14. The system of protecting fish hooks claimed in claim 13, wherein the elongated body being a cylindrical rod having a length l.

15. The system of protecting fish hooks claimed in claim 14, wherein the elongated body being made of an elastic resilient material including a UV protectant to prevent breakdown of the material when exposed to sunlight.

16. The system of protecting fish hooks claimed in claim 15, wherein the elongated body including at least two fins separated by an angle theta defined as the angle subtended between the fins, the fins attached to the body at a body end and terminating at a tip end wherein the fins projecting in a fin direction away from the body such that a trough is defined as the space between the fins, wherein the lure is received within the trough.

17. The system of protecting fish hooks claimed in claim 16, wherein the fins being substantially flat planar surfaces.

18. The system of protecting fish hooks claimed in claim 17, wherein the angle theta preferably between 25 and 155 degrees.

19. The system of protecting fish hooks claimed in claim 18, wherein the fins lying parallel and in mirror image relationship to each other.
